(19) United States
(12) Patent Application Publication
(10) Pub. No.: US 2025/0078086 A1
(43) Pub. Date: Mar. 6, 2025

(54) SYSTEMS AND METHODS FOR SHARED ACCOUNT TRANSACTIONS

(71) Applicant: Wells Fargo Bank, N.A., San Francisco, CA (US)

(72) Inventors: Moses Harris, San Francisco, CA (US); Alan W. Hecht, Chanhassen, MN (US); Timothy Craig Seagren, San Francisco, CA (US); Nadia Van De Walle, San Francisco, CA (US); Jud Murchie, San Francisco, CA (US)

(73) Assignee: Wells Fargo Bank, N.A., San Francisco, CA (US)

(21) Appl. No.: 18/239,908

(22) Filed: Aug. 30, 2023

(51) Int. Cl. G06Q 20/40; G06Q 20/08

(52) U.S. Cl. CPC G06Q 20/405; G06Q 20/0855

(57) ABSTRACT

Systems and methods for generating shared accounts and performing shared account transactions include a computing system which receives a request from a first user device of a first user to form a shared account accessible by a second user based on one or more rules, generates the shared account, links a first account with the shared account, identifies the second user, transmits a notification to a second user device of the second user indicating the second user has access to the shared account, receives an input to the second user device indicating acceptance of access to the shared account, links a second account with the shared account, receives a second input to the second user device indicating a selection to initiate an outbound transfer of resources and a category, determines that the category meets at least one rule, and initiates the outbound transfer of resources from the shared account.

### TECHNICAL FIELD

The present disclosure relates to systems and methods for executing shared account transactions.

### BACKGROUND

Many methods for sharing and transferring resources exist. Conventionally, however, such methods may not be customizable based on user-specific needs, and therefore it may be difficult to effectively manage such resource transfers. For example, in some instances, multiple members at various provider institutions may wish to contribute resources to a common goal, but may have no means to track such contributions. Accordingly, computerized systems and methods to execute shared account transactions from a shared account accessible by multiple members may be desired.

### SUMMARY

This disclosure is directed to systems, methods, and computer-readable media for generating shared accounts and executing shared account transactions. At least one aspect of the disclosure is related to a method. The method comprises receiving, by a computing system, a request from a first user device of a first user, the request to form a shared account accessible by a second user, where the request includes a plurality of rules associated with the shared account; generating, by the computing system, the shared account; linking, by the computing system, a first account of the first user with the shared account; identifying, by the computing system, the second user based on the request to form the shared account; transmitting, by the computing system, a notification to a second user device associated with the second user, the notification indicating the second user has access to the shared account; receiving, by the computing system, an input via the second user device indicating acceptance of access to the shared account; linking, by the computing system, a second account of the second user with the shared account; receiving, by the computing system, a second input via the second user device indicating a selection to initiate an outbound transfer of resources from the shared account to the second account, where the input includes a selection of a category; determining, by the computing system, that the category meets at least one of the plurality of rules; and responsive to determining that the category meets the at least one of the plurality of rules, initiating, by the computing system, the outbound transfer of resources from the shared account to the second account.

At least one aspect of the disclosure is related to a computing system. The computing system comprises a network interface configured to communicate with a plurality of user devices; a first database structured to store a plurality of accounts of a provider; a second database structured to store a plurality of shared accounts; and a processing circuit comprising one or more processors and memory, the processing circuit configured to: receive, via the network interface, a request from a first user device of a first user, the request to form a shared account accessible by a second user, where the request includes a plurality of rules associated with the shared account; generate the shared account; link a first account of the first user with the shared account; identify the second user based on the request to form the shared account; transmit, via the network interface, a notification to a second user device associated with the second user, the notification indicating the second user has access to the shared account; receive, via the network interface, an input to the second user device indicating acceptance of access to the shared account; link a second account of the second user with the shared account; receive, via the network interface, a second input to the second user device indicating a selection to initiate an outbound transfer of resources from the shared account to the second account, where the input includes a selection of a category; determine that the category meets at least one of the plurality of rules; and responsive to determining that the category meets the at least one of the plurality of rules, initiate the outbound transfer of resources from the shared account to the second account.

At least one aspect of the disclosure is related to a non-transitory computer readable medium storing instructions that, when executed by one or more processors of a processing system, cause the processing system to: receive, via a network interface, a request from a first user device of a first user, the request to form a temporary shared account accessible by the first user and by a second user for a period of time, where the request includes a plurality of rules associated with the shared account; generate the shared account; link a first account of the first user with the shared account; identify the second user based on the request to form the shared account; transmit, via the network interface, a notification to a second user device associated with the second user, the notification indicating the second user has access to the shared account; receive, via the network interface, an input to the second user device indicating acceptance of access to the shared account; link a second account of the second user with the shared account; receive, via the network interface, a second input to the second user device indicating a selection to initiate an outbound transfer of resources from the shared account to the second account, where the input includes a selection of a category; determine that the category meets at least one of the plurality of rules; and responsive to determining that the category meets the at least one of the plurality of rules, initiate the outbound transfer of resources from the shared account to the second account.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements. Numerous specific details are provided to impart a thorough understanding of embodiments of the subject matter of the present disclosure. The described features of the subject matter of the present disclosure may be combined in any suitable manner in one or more embodiments and/or implementations. In this regard, one or more features of an aspect of the invention may be combined with one or more features of a different aspect of the invention. Moreover, additional features may be recognized in certain embodiments and/or implementations that may not be present in all embodiments or implementations.

### BRIEF DESCRIPTION OF THE DRAWINGS

FIG. 1 is a block diagram of a computing system for generating a shared account and performing a shared account transaction, according to an example embodiment.

FIG. 2 is a flow diagram of a process for generating a shared account, according to an example embodiment.

FIG. 3 is a block diagram displaying defined rules and attributes of a generated shared account, according to an example embodiment.

FIG. 4 is a flow diagram of a process for withdrawing from a shared account, according to an example embodiment.

FIG. 5A depicts example graphical user interfaces provided to a customer device when resources are deposited to a shared account, according to example embodiments.

FIG. 5B depicts example graphical user interfaces provided to a customer device when resources are withdrawn from a shared account, according to example embodiments.

FIG. 6 depicts example graphical user interfaces provided to various customer devices during a joint payment transaction process using a shared account, according to example embodiments.

### DETAILED DESCRIPTION

Referring generally to the figures, systems and methods for generating and providing a shared account and executing a shared account transaction are disclosed according to various embodiments described herein. According to the various embodiments described herein, a provider computing system may provide end-users an application (e.g., via their respective devices) which facilitates establishing and maintaining a shared account. In some instances, the systems and methods described herein may allow a user to initiate a resource transfer from a financial account owned by the user to the shared account. The provider computing system may allow a user to apply various rules associated with the resource transfer. For example, beneficially, the provider computing system may allow users to earmark resources within the shared account for specific purposes. The systems and methods described herein may allow a user to request to initiate an outbound resource transfer from the shared account to a financial account owned by a user. Responsive to receiving a request to initiate an outbound resource transfer, the provider computing system may determine whether the request meets one or more rules defined by the shared account, such as whether the resources were earmarked. Furthermore, the systems and methods described herein generate and provide various user interfaces to a device of a user to allow fund transactions, view fund transaction history, determine whether an outbound transfer request was approved or denied, manage attributes, such as an expiration date of the shared account, and various other functionalities described herein.

As an example, a first user can request to establish a shared account and can invite other users to access the shared account. The first user can define various rules associated with deposits and withdrawals to or from the shared account, which may be specific to certain members of the shared account. For example, the first user can define a time period for the shared account to remain active, and necessary deposit requirements for each member of the shared account. The first user can further define one eligible member for making withdrawals from the shared account. Beneficially, the shared account can allow members contributing towards a common balance goal (e.g., a mortgage payment, a rental payment, etc.) to equally contribute to the goal.

Technically and beneficially, the systems and methods described herein provide various technical solutions to the various problems and shortcomings of conventional resource transfer systems as alluded to above. For example, the systems and methods described herein operate in a non-conventional way by allowing generation of a temporary shared account having predefined rules for withdrawals and transactions, by coupling users in a non-conventional way for a shared balance goal, by allowing users to earmark specific resources for specific purposes, and by automatically dividing resources in the shared account to various users at the expiration of the shared account, in some instances unequally based on contribution and withdrawal characteristics associated with transactions associated with the shared account and characteristics of the users. For example, allowing members that share a common goal (e.g., to make a rent payment) to pool resources into a shared account for only a predetermined period of time (e.g., for the term of a lease agreement) is non-conventional and creates a practical application by managing a pool of resources efficiently and fairly. Various other technical benefits and advantages are described in greater detail below.

Before turning to the figures, which illustrate certain example embodiments in detail, it should be understood that the present disclosure is not limited to the details or methodology set forth in the description or illustrated in the figures. It should also be understood that the terminology used herein is for the purpose of description only and should not be regarded as limiting.

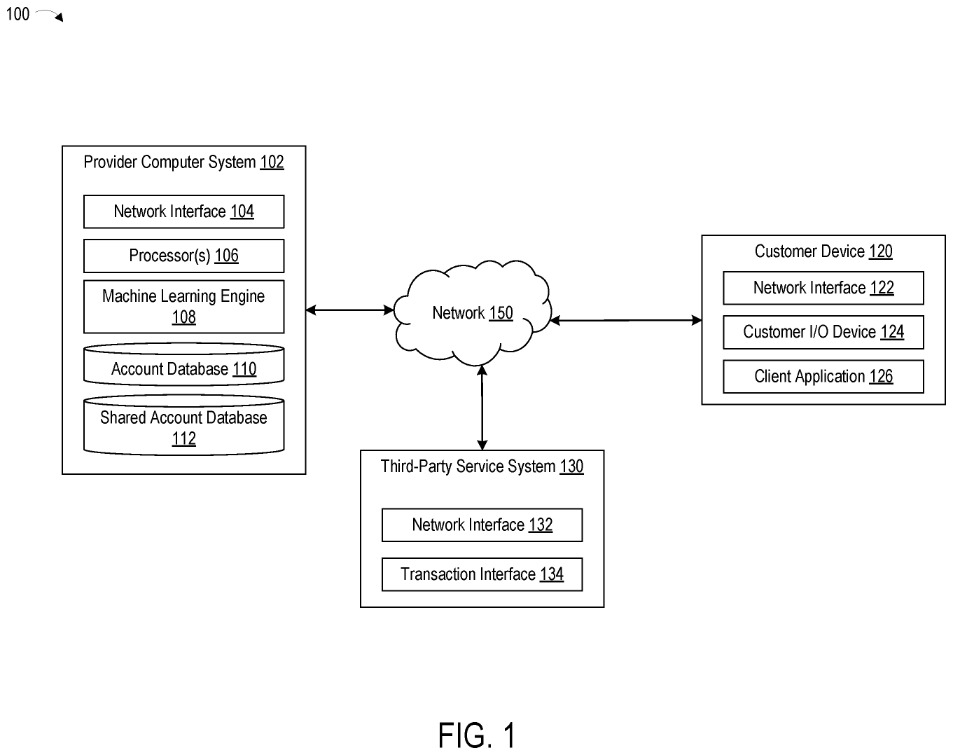

FIG. 1 is a diagram of a computing environment 100 for generating one or more shared accounts and performing shared account transactions, according to an example embodiment. As shown, the computing environment 100 includes one or more provider computing systems 102 associated with a provider (e.g., a service provider, or a financial institution such as a bank or a credit union), one or more customer devices 120 associated with one or more users, one or more third-party service systems 130, and a network 150 which may include one or more of the Internet, cellular network, Wi-Fi, Wi-Max, a proprietary banking network, or any other type of wired or wireless network or a combination of wired and wireless networks. As described herein, the computing environment 100 may be used to provide a user interface to the one or more customer devices 120 to allow for easy account management and resource management between and/or across various accounts of one or more users.

For clarity, the following description will refer to a provider computing system 102, one or more customer devices 120, and a third-party service system 130. However, it will be understood that the following description of any of these devices and computing systems will be similarly applicable to any additional corresponding devices and computing systems (e.g., additional provider computing systems 102) and that, in some embodiments, the computing environment 100 may include a plurality of any of the described devices and systems.

The provider computing system 102 may be owned by, associated with, or otherwise operated by a provider that maintains one or more accounts held by various customers (e.g., the customer associated with the customer device 120), such as demand deposit accounts, credit card accounts, receivables accounts and so on. As described in greater detail herein, the provider computing system 102 may be configured to maintain one or more shared or joint accounts held or maintained for a plurality of customers or users (also referred to as “members” herein). Such a shared account may be accessible by each of the plurality of customers or users, such that the customers or users may be capable of transferring funds between (e.g., to and/or from) the shared account and an individual (e.g., non-shared, such as business or personal) account. The shared account may be shared across multiple customers or users. The shared account may be configured with defined deposit and/or withdrawal rules to effectively allow users to manage the shared account.

In some embodiments, the provider computing system 102 may include one or more servers, each with one or more processing circuits having one or more processors 106 configured to execute instructions stored in one or more memory devices to send and receive data stored in the one or more memory devices and perform other operations to implement the methods described herein associated with logic or processes shown in the figures. In some embodiments, the provider computing system 102 may be or may include various other devices communicably coupled thereto, such as, for example, desktop or laptop computers (e.g., tablet computers), smartphones, wearable devices (e.g., smartwatches), virtual reality devices (e.g., headsets), and/or other suitable devices.

In some embodiments, the provider computing system 102 includes a machine learning engine 108, an account database 110, a shared account database 112, and a network interface 104. In some embodiments, the network interface 104 includes, for example, program logic that connects the provider computing system 102 to the network 150. The network interface 104 facilitates secure communications between the provider computing system 102, customer device(s) 120, and/or a third-party service system 130, such as a third-party computing system. The network interface 104 also facilitates communication with other entities such as other providers or banks, settlement systems, and so on. The network interface 104 further includes user interface logic configured to generate and present web pages and graphical user interfaces to users accessing the provider computing system 102 over the network 150. In some embodiments, the machine learning engine 108 may be configured to use one or more machine learning models stored in the shared accounts database 112, as described herein.

The account database 110 is structured or configured to contain, store, include, or otherwise maintain information on financial accounts associated with the provider. Additionally, the account database 110 may contain transaction information, information pertaining to the type and corresponding capabilities of a given account. Similarly, the shared account database 112 is structured or configured to maintain a plurality of shared accounts and associated information (e.g., shared account members, linked financial accounts, customer device information, etc.). As described in greater detail below, the provider computing system 102 may be configured to generate, create, or otherwise establish new shared accounts (e.g., responsive to receiving one or requests from various user devices). As part of establishing shared accounts, the provider computing system 102 may be configured to generate various notifications and/or inputs to devices associated with shared members (e.g., members identified in the request with which the shared account is to be shared) to establish and define rules associated with the shared account.

The customer device 120 is owned by, operated by, controlled by, managed by, and/or otherwise associated with a customer (e.g., a customer of the provider). In some embodiments, the customer device 120 may include, for example, a desktop or laptop computer (e.g., a tablet computer), a smartphone, a wearable device (e.g., a smartwatch), a personal digital assistance, a virtual reality device (e.g., virtual reality headset), and/or any other suitable computing device. In the example described herein, the customer device 120 is structured as a mobile computing device, namely a smartphone.

The network interface 122 of the customer device 120 includes, for example, program logic and various devices (e.g., transceivers, etc.) that connect the customer device 120 to the network 150. The network interface 122 facilitates secure communications between customer device(s), third-party service systems 130, and/or the provider computing system 102. The network interface 122 also facilitates communication with other entities, such as other banks, settlement systems, and so on.

In some embodiments, the customer device 120 includes one or more I/O devices 124, and one or more customer client applications 126. While the term “I/O” is used, it should be understood that the I/O devices 124 may be input-only devices, output-only devices, and/or a combination of input and output devices. In some instances, the I/O devices 124 include various devices that provide perceptible outputs (such as display devices with display screen and/or light sources for visually perceptible elements, an audio speaker for audible elements, and haptics or vibration devices for perceptible signaling via touch, etc.), that capture ambient lights and sounds (such as digital cameras, microphones, etc.), and/or that allow the customer to provide inputs (such as a touchscreen display, stylus, keyboard, force sensor for sensing pressure on a display screen, acceleration sensor for tracking motion, etc.). In some instances, the I/O devices 124 further include one or more user interfaces (devices or components that interface with the customer), which may include one or more biometric sensors (such as a fingerprint reader, a heart monitor that detects cardiovascular signals, face scanner, an iris scanner, etc.).

The customer device 120 stores in computer memory and executes (“runs”) using one or more processors, various customer client applications 126, such as an Internet browser presenting websites, text messaging applications (e.g., for sending MMS or SMS to the provider computing system 102, another customer device 120, and/or the third-party service system 130), and/or applications provided or authorized by entities implementing or administering any of the computing systems in computing environment 100.

In some embodiments, the client applications 126 may include a customer provider institution client application (e.g., a financial institution banking application) provided by and at least partly supported by the provider computing system 102. For example, in some instances, the client application 126 coupled to the provider computing system 102 may enable the customer to perform various customer activities (e.g., transferring money to another financial account, etc.) associated with one or more customer accounts of the customer held at the provider institution associated with the provider computing system 102 (e.g., account opening and closing operations, fund transfers, etc.).

The third party service system 130 is controlled by, managed by, owned by, and/or otherwise associated with a third party service entity (e.g., the Early Warning Service (“EWS”), credit agencies (e.g., TransUnion, Equifax, Experian, etc.), or other third-party service providers used by the provider) and is configured to receive and/or transmit data with the provider computing system 102 and/or the customer devices 120. In some embodiments, the third party service system 130 may, for example, comprise one or more servers, each with one or more processing circuits including one or more processors configured to execute instructions stored in one or more memory devices, send and receive data stored in the one or more memory devices, and perform other operations to implement the operations described herein associated with certain logic and/or processes depicted in the figures.

Although not specifically shown, it will be appreciated that the third party service system 130 may include a network interface 132, a transaction interface 134 (e.g., to facilitate allowing transactions between the financial institution associated with the provider computing system 102 and a third party financial institution registered with the third party service system 130), various databases (e.g., similar to the account database 110 and/or the shared account database 112), an account management engine, and/or other processors in the same or similar manner to the other components of computing environment 100. In some instances, the network interface 132 may include user interface program logic configured to generate and present application pages, web pages, and/or various other data to users accessing the third party service system 130 over the network 150. As described herein, the third party service system 130 (e.g., Zelle®) may be configured to allow members of different financial institutions to deposit to and/or make withdrawals from a shared account of the provider computing system 102.

With an example structure of the computing environment 100 being described above, example processes performable by the computing environment 100 (or components/systems thereof) will be described below. It should be appreciated that the following processes are provided as examples and are in no way meant to be limiting. Additionally, various method steps discussed herein may be performed in a different order or, in some instances, completely omitted. These variations have been contemplated and are within the scope of the present disclosure.

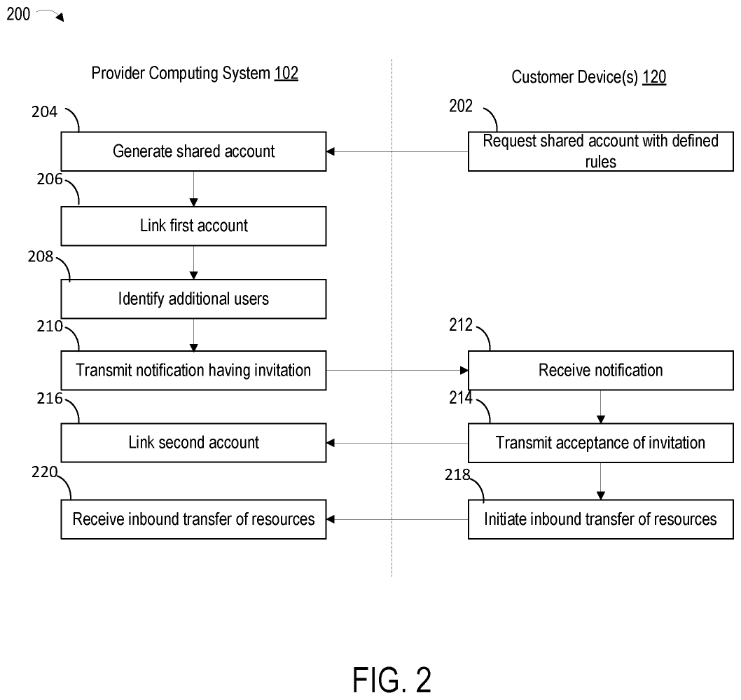

Referring now to FIG. 2, depicted is a flowchart showing an example method 200 of generating a shared account, according to an example embodiment of the present disclosure. The method 200 may be performed by the components, elements, or hardware described above with reference to FIG. 1 (for example, the provider computing system 102 and various customer devices 120). In various embodiments, one customer device 120 may perform one or more of the steps, the provider computing system 102 may perform one or more other steps, and one or more additional customer devices 120 may perform one or more of the steps. In this regard, the various steps of the method 200 may be performed by various combinations of the devices/elements/hardware described above with reference to FIG. 1.

In summary, at step 202, a first customer device 120 may request to generate a shared account with a plurality of predefined rules and attributes associated with the shared account. At step 204, the provider computing system 102 may generate the shared account. At step 206, the provider computing system 102 may link a first account associated with the first customer device 120 with the shared account. At step 208, the provider computing system 102 may identify additional users to provide access to the shared account. At step 210, the provider computing system 102 may transmit a notification to one or more secondary customer devices 120 including an invitation to the shared account. At step 212, the one or more secondary devices 120 may receive the notification. At step 214, the one or secondary customer devices 120 may transmit an indication of an acceptance of the invitation to join the shared account to the provider computing system 102. At step 216, the provider computing system 102 may receive the acceptance and link a second account associated with one or more secondary customer devices 120 with the shared account. At step 218, the first customer device 120 or one or more secondary customer devices 120 may initiate a transfer of resources to the shared account. At step 220, the provider computing system 102 may receive the inbound transfer of resources.

At step 202, a customer device 120 (e.g., a first customer device 120) may generate, create, or otherwise provide a request to generate a shared account. The customer device 120 may generate the request based on or according to various inputs received via the customer I/O device 124 to the client application 126. The customer device 120 may generate the request to include information/data/inputs provided by a user (e.g., a first user) of the customer device 120 to the client application 126. The inputs may include, for example, information identifying a first account of the user (e.g., an account in the account database 110, such as an account number), information identifying one or more second users in which to share the account (e.g., usernames, email addresses, phone numbers, IP addresses, or other identifiers associated with the second users), etc. The customer device 120 may be configured to transmit, communicate, send, or otherwise provide (e.g., via the network interface 122 over the network 150) the provider computing system 102 with the request.

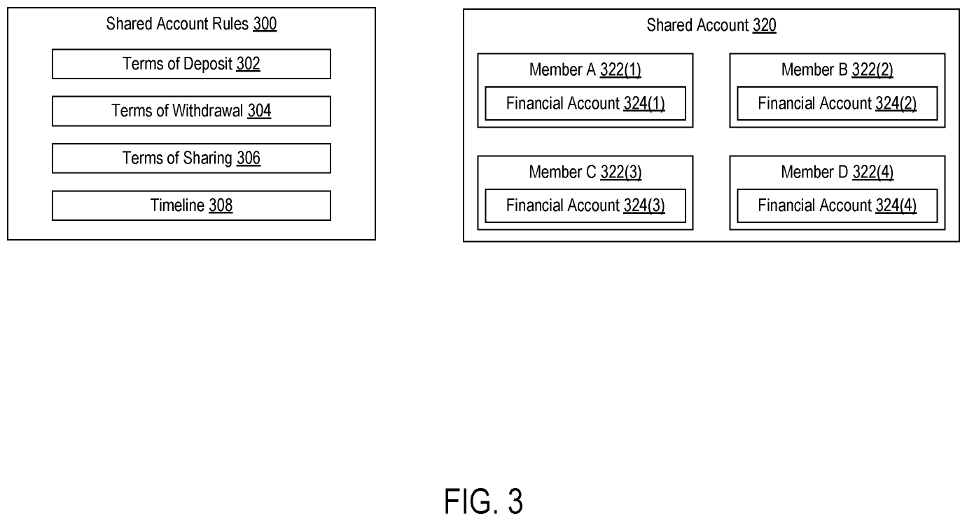

In some embodiments, the request may define a plurality of rules and/or attributes associated with the shared account. For example, the various inputs received via the customer I/O device 124 to the client application 126 may additionally or alternatively include a selection of rules governing deposits to the shared account, rules governing withdrawals from the shared account, rules governing time limits for the shared account, rules governing earmarking funds for the shared account, among other rules described herein (e.g., with reference to FIG. 3). In some embodiments, for example, responsive to receiving an input to the client application 126 indicating a user wishes to generate a shared account, the customer device 120 may be configured to automatically render a user interface on the client application 126 displaying a plurality of selectable elements for a user to define the rules. By way of example, the client application 126 may receive inputs selecting eligible members (e.g., using identifiers described herein) for withdrawing from the shared account, eligible members for depositing to the shared account, a period of time in which members can withdraw from the shared account, an amount of withdrawals allowed within a period of time, withdrawal and/or deposit limits, an expiration date of the shared account, deposit requirements of each member, how funds within the shared account are to be shared, among other rules and attributes described herein.

At step 204, the provider computing system 102 may receive (e.g., via the network interface 104) the request from the customer device 120 (e.g., responsive to the customer device 120 generating and transmitting the request) and create, establish, or otherwise generate the shared account defined by the one or more rules. In some embodiments, the provider computing system 102 may generate the shared account in the shared account database 112. The provider computing system 102 may generate the shared account by creating or establishing a new account number (e.g., associated with the shared account), and creating a link between one or more accounts of the account database 110 and the shared account.

For example, at step 206, the provider computing system 102 may generate a link between the shared account and the first account (e.g., for the user of the first customer device 120) based on or according to the information identifying the first account from the request.

At step 208, the provider computing system 102 may determine, detect, or otherwise identify one or more secondary users to be given access to the shared account. The second users may be or include users which are identified in the request and which are to be provided access to the shared account. The provider computing system 102 may identify the shared customers based on or according to the information included in the request received at step 204. As stated above, as part of generating the request, a user of the first customer device 120 may include various identifiers associated with shared customers. The provider computing system 102 may identify the shared customers by performing a look-up function using the identifiers from the request in the account database 110. In some embodiments, the provider computing system 102 may generate one or more temporary and/or permanent links between identified accounts (e.g., identified responsive to or based on a returned result from the look-up function) in the account database 110 and the shared account.

At step 208, the provider computing system 102 may generate and communicate, transmit, send, or otherwise provide one or more notifications to customer devices 120 associated with the identified shared customers. In some embodiments, the request received at step 204 may include a phone number or email address associated with the shared customer. The provider computing system 102 may provide the notification to the phone number (or email address) included in the request. In some embodiments, the provider computing system 102 may provide the notification to a different address or device of a user responsive to performing the look-up function (if, for example, the user has a preferred mode of communication stored in association with the user's account in the account database 110 but not included in the request). The notification may include an invitation to join the shared account. For example, the notifications may be or include an alert indicating or requesting enrollment of the user in the shared account (e.g., generated at step 206). The notifications may include a user interface for selecting or providing information relating to an account in which to link the shared account. The account of the user may be an account in the account database 110, or an account of a different financial provider (e.g., maintained by a third-party provider). For example, the account at a different financial provider may initiate transfers of resources with the shared account via a third party service system 130.

At step 212, one or more customer devices 120 (e.g., secondary devices of shared customers or users) may receive the notification. The customer devices 120 may receive the notification(s) sent by the provider computing system 102 over the network 150 via the network interface 122. The customer devices 120 may receive the notification(s) as a pop-up or alert corresponding to the client application 126. The notification may include a prompt, user interface element, or other field for responding to the request to enroll. For example, the notification may include a user interface element (e.g., an enroll button) for selecting to enroll in the shared account, and another user interface element (e.g., a decline button) for declining the invitation to enroll in the shared account. The notification may include a listing of the predefined rules associated with the shared account (e.g., received by the provider computing system 102 at step 204). In some embodiments, the notification may include a selectable component such that a user must agree to enroll in the shared account by interacting with the notification. At step 212, the customer device 120 may receive a selection to accept the invitation and/or the rules to enroll in the shared account (e.g., by the user selecting via the I/O device 124 the user interface element to enroll in the shared account).

At step 214, the customer device 120 may log into the client application 126 or otherwise access/register with the client application 126 to transmit the acceptance to the provider computing system 102, and to (e.g., at step 216) add or link the shared account with a second account of the second user. In some embodiments, the user of the customer device 120 may have an account associated with the provider computing system 102 (e.g., an account identified or maintained in the account database 110). In such embodiments, the user of the customer device 120 may log into the client application 126 and select the account identified or included in the client application 126. In some embodiments, the user of the customer device 120 may have an account with a different provider (or may otherwise link the shared account with an account outside of the provider associated with the provider computing system 102). In such embodiments, the user of the customer device 120 may create or establish an account with the client application 126. Once the account is established, the user may provide various inputs for establishing the link between the shared account and the customer's account. For example, the user may provide inputs for establishing the link by providing a routing and account number of the customer's account to a user interface of the client application 126. As another example, the user may provide inputs for establishing the link by selecting a provider associated with the customer's account on, e.g., a drop-down menu, log-into a portal associated with the selected provider, and select the corresponding account in which to establish the link.

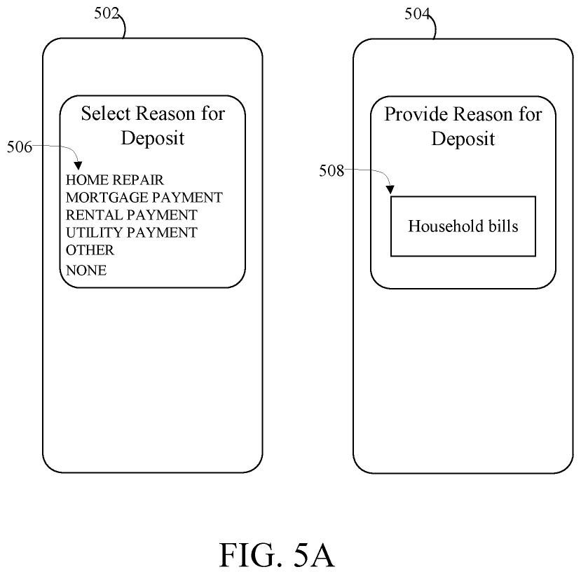

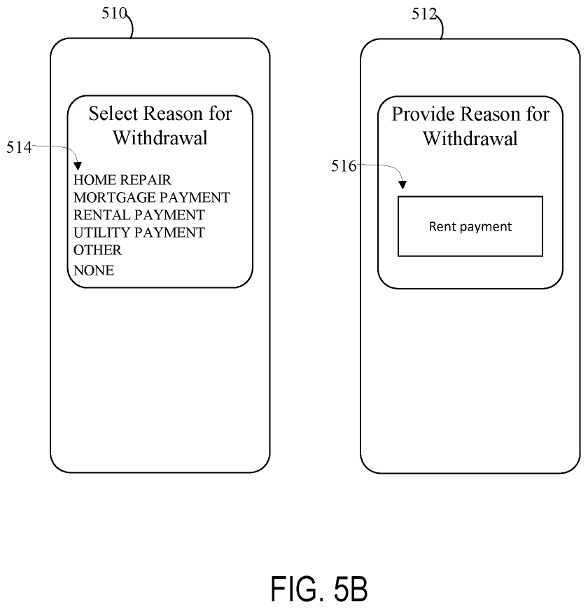

At step 218, the provider computing system 102 may receive a request to initiate an inbound transfer of resources (e.g., funds). For example, the provider computing system 102 may receive a request to initiate a transfer of funds from the first account associated with the first customer device 120 to the shared account. In some embodiments, the resources (e.g., funds) may be earmarked for a specific purpose. For example, the funds may be earmarked based on the withdrawal rules defined at steps 202 and 204, or the funds may be earmarked during the deposit via inputs to the user interface displayed on the client application 126 of the first customer device 120, as described in greater detail herein with reference to FIG. 5A.

Referring now to FIG. 3, a block diagram of shared account rules 300 displaying configurable items for a shared account and a representation of the shared account 320 are shown, according to an example implementation of the present disclosure. The shared account rules 300 and shared account 320 may be stored in the shared account database 112. The shared accounts rules 300 may be updated/configured as part of generating the request at step 202 described above. In some embodiments, the shared account rules 300 may be or include account attributes of the shared account, such as whether the shared account is a lending shared account (e.g., an account in which members can selectively obtain a loan with funds from the lending account), a shared savings account (e.g., an account in which members can contribute for savings), etc.

In some embodiments, the shared account may include terms of deposit 302, which may designate various conditions and/or inputs a user must complete in order for the account to be eligible for deposit and/or specific amounts or times in which a user must deposit to the shared account to maintain access to the shared account. The terms of withdrawal 304 may designate various requirements associated with the shared account in order for the account to be eligible to withdraw. The terms of sharing 306 may define how resources in the shared account are split up among accounts with access to the shared account if or when the shared account is closed. In some instances, as described herein, the terms of sharing 306 may be determined at random. In other instances, the terms of sharing 306 may be determined dynamically, for example, by individual account transaction history. In still some instances, the terms of sharing 306 may be divided up equally. The timeline 308 may set an amount of time that the shared financial account is active and capable of receiving deposits and/or withdrawals. In some instances, the timeline 308 may be indefinite. In some instances, the timeline 308 may indicate to close the shared account after a predetermined period of time (1 week, 1 year, 5 years, 25 years, etc.).

The shared account 320 retains a plurality of connected users 322 and their respective linked financial account 324. Each connected or registered user 322 may register with the shared account 320 as described above with reference to steps 206-216 of FIG. 2. Additionally, the connected users 322 may be configured to connect (e.g., add or link) the shared account with a financial account 324 of the user (e.g., an individual, or non-shared account). The financial account 324 may be an account in the account database 110 (e.g., an account with the provider of the provider computing system 102), or may be a third-party account (e.g., an account with a third-party financial provider or institution). Accordingly, such third-party financial account 324 may require interaction with the third-party service system 130 in order to initiate inbound and/or outbound transfers of funds or receive transaction history. For example, each user 322 may register with the third-party service system 130 (e.g., by providing account information to the third party service system 130) in order to transfer funds between external financial institutions to contribute to the shared account 320.

The users may link the financial account 324 with the shared account 320 as described above with reference to steps 206 and 216 of FIG. 2. While shown as four users or members linked to the shared account 320, it is noted that any number of users (e.g., greater than or equal to two) can be linked to the shared account 320. In some instances, one user may be defined (e.g., according to the rules defined in steps 202 and 204 of FIG. 2) as an administrator or owner of the shared account. The administrator may be allowed to update, via one or more inputs to the client application 126 of their respective customer device 120, one or more rules associated with the shared account. For example, the provider computing system 102 may be configured to generate authorization credentials (e.g., a unique ID and/or password) when linking the first account with the shared account at step 206 in FIG. 2. The provider computing system 102 may be configured to transmit the generated authorization credentials to the first customer device 120 responsive to linking the first user account with the shared account. The provider computing system 102 may be configured to dynamically update one or more rules of the shared account responsive to receiving the generated authorization credentials as an input to the first customer device 120.

Referring back to FIG. 1, and as described above, in some embodiments, the shared account may be or include a shared savings account or other account type, such as a shared checking account. The shared savings account may be or include an account in which members contribute to a shared balance. As part of enrollment and at various intervals, shared account members may transfer funds from personal (or individual accounts) to the shared account, to increase the account balance. Similarly, one or more of the shared account members may access the shared account at various intervals.

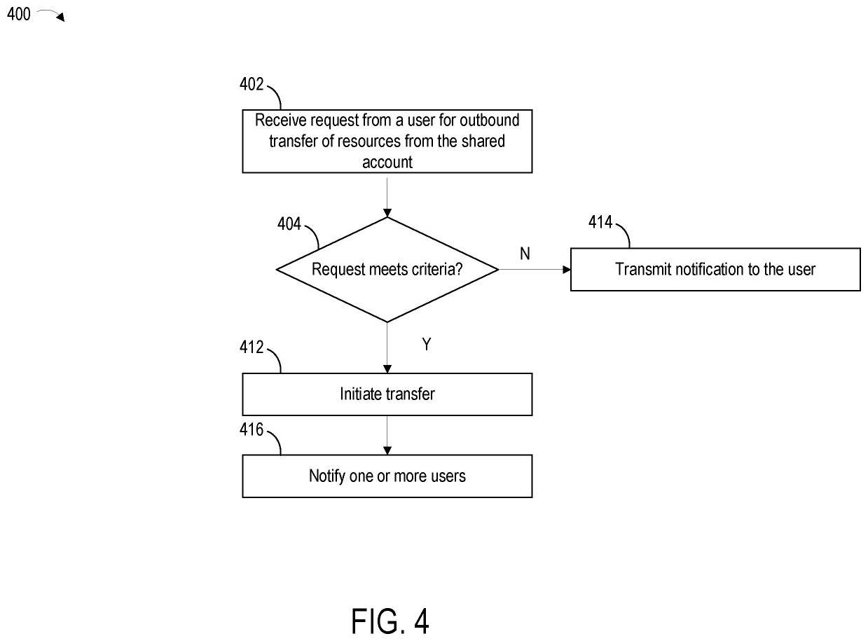

Referring to FIG. 4 in connection with FIGS. 1-3, depicted is a flowchart showing an example method 400 of initiating transfers between a shared account and an individual account, according to an example implementation of the present disclosure. The method 400 may be performed by the devices, components, or elements described above with reference to FIG. 1-FIG. 3. For example, the method 400 may be performed or executed by the provider computer system 102 of FIG. 1.

In some embodiments, the method 400 may be performed responsive to or following execution of the method 200 of FIG. 2. In other words, the method 400 may be performed responsive to the shared account being generated. As stated above with reference to FIG. 3, the shared account may include various shared account rules 300 which may be set, established, or otherwise defined for the shared account. The shared account rules 300 may include, for example, terms of deposit 302, terms of withdrawal 304, terms of sharing 306, and timelines 308. The users 322 may contribute to the shared account at various intervals.

At step 402, the provider computing system 102 may receive, from one or more customer devices 120, a request to initiate an outbound transfer of resources (e.g., funds) from the shared account to a linked personal account of the user. In other words, the provider computing system 102 may receive a request to withdraw funds from the shared account. The provider computing system 102 may receive the request from a customer device 120 associated with a user who may or may not be the administrator of the shared account (e.g., from a secondary user of the shared account).

At step 404, responsive to receiving the request, the provider computing system 102 may be configured to determine whether the withdrawal request meets at least one criteria of the shared account (e.g., whether the request is consistent with the shared account rules 300). In some embodiments, the terms of withdrawal 304 may identify one or more specific users of the shared account who are allowed to withdraw from the shared account. In such embodiments, the provider computing system 102 may be configured to identify the user associated with the withdrawal request to determine if the user is eligible for withdrawals (e.g., based on an account number of the user, based on an IP address of the customer device 120 associated with the user, or through various other identifiers described at step 202 in FIG. 2). For example, the provider computing system 102 may be configured to parse information stored in the shared account database 112 and compare the information with the one or more identifiers of the user making the withdrawal request to determine if the user is eligible for withdrawing funds.

In some embodiments, the terms of withdrawal 304 may indicate that a subset, or an entirety, or the resources within the shared account are earmarked for a particular purpose. In such embodiments, the terms of withdrawal 304 may include a list including a finite number of categories and/or keywords associated with the earmarked funds. For example, the provider computing system 102 may be configured to receive a selection of a category or keyword with an inbound transfer of funds (e.g., deposit) from a first user. In some embodiments, the provider computing system 102 may be configured to transmit a prompt to render on a customer device 120 (e.g., via the client application 126) automatically when a request to deposit funds is initiated from the customer device 120. For example, FIG. 5A depicts examples of user interfaces 502, 504 provided to a customer device 120 responsive to the customer device 120 receiving a request to initiate an inbound transfer of funds. In some embodiments, the provider computing system 102 may be configured to transmit a prompt to the customer device 120 responsive to receiving an input to the client application 126 on the customer device 120 indicating the user wishes to earmark the deposited funds (e.g., by receiving an input to a user interface element, such as “earmark funds”).

As depicted in the example user interface 502, in some embodiments, the provider computing system 102 may be configured to transmit a prompt to render on the customer device 120 including a list 506 of one or more selectable categories responsive to receiving a request to deposit funds to the shared account. The categories may be defined in the terms of deposit 302, and stored in the shared account database 112, at the time of generating the shared account (e.g., by the first user requesting to generate the shared account) and/or by an administrator of the shared account after the shared account is generated by the provider computing system 102. Responsive to receiving an input to one of the selectable categories, the provider computing system 102 may be configured to store, in the shared account database 112, an amount of the deposit and the selected category. By way of example, a user may deposit $100 into the shared account indicating the funds are earmarked for home repair.

As depicted in the example user interface 504, in some embodiments, the provider computing system 102 may be configured to transmit a prompt to render on the customer device 120 including a dialogue box 508 responsive to receiving a request to deposit funds to the shared account. The dialogue box 508 may be configured to receive various text inputs (e.g., letters, words, and/or numbers). In some instances, the provider computing system 102 may be configured to cause the customer device 120 to render the dialogue box responsive to parsing the shared account database 112 and determining that no categories have been defined for earmarking funds in the shared account. Responsive to receiving an input to the dialogue box, the provider computing system 102 may be configured to store, in the shared account database 112, an amount of the deposit and the inputted text. By way of example, a user may deposit $1000 into the shared account indicating the funds are earmarked for “household bills.”

FIG. 5B depicts example user interfaces 510, 512 rendered on a customer device 120 responsive to receiving the withdrawal request from the customer device 120 (e.g., from the second customer device 120). As depicted in the example user interface 510, in some embodiments, the provider computing system 102 may be configured to transmit a prompt to render on the customer device 120 including a list 514 of predefined categories. In some embodiments, the list 514 of categories rendered on a customer device 120 responsive to receiving a withdrawal request may be the same as the list 506 of categories rendered on a customer device 120 responsive to receiving a deposit request. In other embodiments, the lists 506, 514 may include one or more different selectable categories or options (e.g., the provider computing system 102 may be configured to parse the shared account database 112 and randomly select additional categories to provide with the prompt).

Responsive to receiving an input to a selectable category of the list 514 of selectable categories, the provider computing system 102 may be configured to compare the selected category with earmarked fund information stored in the shared account database 112. If the provider computing system 102 determines the selected category matches at least one category stored in the shared account database 112, the provider computing system 102 may be configured to approve the withdrawal request in the amount equal to the withdrawal request, up to the amount associated with the category. By way of example, if the terms of withdrawal 304 indicate $3000 of funds are earmarked for the category “mortgage payment,” and a user is requesting to withdraw between $0-$3000 for a mortgage payment, the provider computing system 102 may be configured to approve the request. If a user is requesting to withdraw more than $3000, the provider computing system 102 may be configured to deny the request or only approve a withdrawal of $3000. Similarly, if the user is requesting to withdraw $3000 for “none” of the reasons displayed in the list 514, the provider computing system 102 may be configured to deny the request.

As depicted in the example user interface 512, in some embodiments, the provider computing system 102 may be configured to transmit a prompt to render on the customer device 120 including a dialogue box 516 configured to receive a text input. Responsive to receiving an input to the dialogue box 516, the provider computing system 102 may be configured to compare the inputted text with earmarked fund information stored in the shared account database 112. If the provider computing system 102 determines the inputted text exactly matches at least one category and/or keyword (from the dialogue box 508 associated with a deposit) stored in the shared account database 112, the provider computing system 102 may be configured to approve the withdrawal request in the amount equal to the withdrawal request, up to the amount associated with the category. If the provider computing system 102 determines the inputted text does not exactly match any stored categories and/or keywords in the shared account database 112, the provider computing system 102 (e.g., via the machine learning engine 108) may be configured to access one or more machine learning models stored in the shared account database 112 to determine if the inputted text is related to any of the stored categories or keywords.

For example, the machine learning models may be trained using historical data stored within the shared account database 112. The various machine learning models may include neural networks (e.g., convolutional neural networks, deep neural networks), Support Vector Machines (SVMs), Random Forests, or the like. The machine learning models may be trained on known input-output pairs given known inputs. For example, the machine learning models may be trained to predict a category or keyword based on a plurality of known inputs and outputs (e.g., keyword associations, etc.) By way of example, the provider computing system 102 may receive various text inputs to the dialogue box 508. The provider computing system 102 may extract a plurality of instances of the words “household” and “bills” inputted to the dialogue box 508. The provider computing system 102 (e.g., via the machine learning engine 108) may use the one or more machine learning models to determine, based on previous inputs to the dialogue box 508, that the words “household” and “bills” are associated with the home repairs, mortgage or rental payments, utility payments, or other household transaction items.

Responsive to determining that the inputted text into the dialogue box 516 matches one or more categories or keywords stored in the shared account database 112 (e.g., by an exact match or by using one or more machine learning models), the provider computing system 102 may be configured to approve the withdrawal request. Responsive to determining that the inputted text does not match and/or is not related to any of the categories or keywords stored in the shared account database 112, the provider computing system 102 may be configured to deny the withdrawal request.

In some embodiments, the terms of withdrawal 304 may indicate a period of time in which withdrawals are allowed and/or a finite number of withdrawals allowed over a period of time. In such embodiments, the provider computing system 102 may be configured to parse the shared account database 112 to determine whether the withdrawal request falls within the allotted period of time for withdrawals and/or whether the amount of withdrawals has not exceeded a threshold amount. By way of example, a user may indicate a certain amount of funds (or all funds in the shared account) are only to be withdrawn after a period of time has passed and/or within a period of time (e.g., a user may be a parent establishing funds for a child to access when the child turns 18, etc.).

Referring back to FIG. 4, responsive to determining that the withdraw request meets at least one criteria associated with the shared account rules 300 (e.g., the withdrawal is initiated by an eligible user, the withdrawal matches earmarked funds, the withdrawal is requested at a certain date or time, etc.), the provider computer system 102 may initiate the outbound transfer of funds from the shared account to the account associated with the user requesting to withdraw funds that is linked to the shared account at step 412. In some embodiments, at step 416, the provider computer system 102 may transmit, send, or otherwise provide a notification to one or more customer devices 120 responsive to initiating the transfer of funds. The provider computer system 102 may provide the notification to the customer device 120 associated with the user who requested the withdrawal of funds and/or to various other users with access to the shared account identified or determined at step 208 in FIG. 2. The provider computer system 102 may provide the notification to the one or more customer devices 120 by sending a notification to an application executing on the customer device 120. The notification may indicate that funds have been withdrawn from the shared account. In some instances, the notification may indicate a name of the user who withdrew the funds and/or another identifier of the user. In some embodiments, the provider computing system 102 may be configured to provide the notification to the customer device 120 associated with an administrator of the shared account.

Responsive to determining that the withdraw request does not meet at least one criteria associated with the shared account rules 300 (e.g., the withdrawal is initiated by an ineligible user, the withdrawal does not match earmarked funds, the withdrawal is requested outside a designated period of time, etc.), the provider computer system 102 may deny the request and may transmit, send, or otherwise provide a notification to the customer device 120 associated with the user who requested the withdrawal at step 414. The notification may indicate that the request was denied and/or a reason for denial of the request.

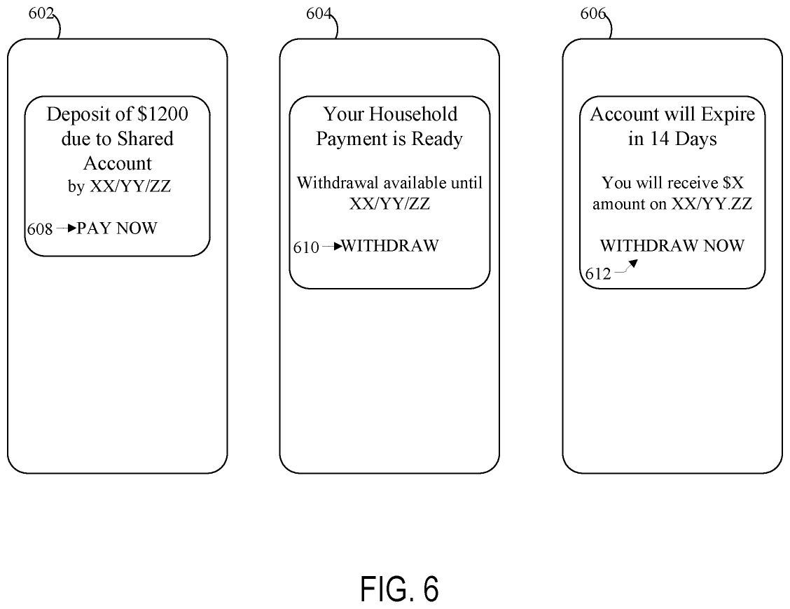

Referring now to FIG. 6, which depicts example user interfaces 602, 604, 606 provided to various customer devices 120, in some embodiments, the shared account may be used by members of a common household, or other community, to reach a common goal. For example, the shared account may be used by members leasing a house and/or paying rent or other payments to a common landlord or other payee. In some embodiments, the terms of deposit 302 may define members eligible to deposit to the shared account (e.g., members of the common household) and/or a payment amount, time, and/or date of required deposits to the shared account. For example, the terms of deposit 302 may define a recurring payment (e.g., a rental payment, a utility payment, etc.) made over a period of time.

Based on the terms of deposit 302, the provider computing system 102 may be configured to generate, transmit, or otherwise provide a notification to at least one and/or all of the customer devices 120 associated with members with access to the shared account. The notification may indicate that a deposit is due by a certain date or time, as depicted in the example user interface 602 in FIG. 6. The provider computing system 102 may be configured to provide the notification to each of the members with access to the shared account (e.g., via each of their respective customer devices 120). In some embodiments, the terms of deposit 302 may define an amount owed and/or a balance goal set for the members of the shared account. For example, the amount may be the amount of a full rental payment due each month. The provider computing system 102 may be configured to divide the full payment by the amount of members with access to the shared account to determine the deposit owed by each member. In some embodiments, in which an exact amount is not known (e.g., for recurring or upcoming bills, such as a utility bill), the terms of deposit 302 may define a balance goal earmarked for the payment that may be greater than or equal to an average amount of historical payments (e.g., based on information stored in the shared account database 112). By way of example, if a utility bill was $100 one month, the provider computing system 102 may be configured to determine a balance goal is $150 (e.g., a certain percentage more than the average or previous bill). If the bill is less than the balance goal, the provider computing system 102 may be configured to divide up the remaining balance among the members of the shared account after a period of time, as described in greater detail herein.

The notification may include a selectable option to make the deposit (e.g., the “pay now” user interface element 608 of user interface 602). The notification may additionally or alternatively include a selectable option to make the deposit later and/or decline making the deposit. In some embodiments, responsive to receiving an input to the user interface 602 indicating the user declines making the deposit, the provider computing system 102 may be configured to generate, transmit, or otherwise provide a prompt to be rendered on the customer device 120 including a dialogue box for the user to indicate why the deposit is declined. Responsive to receiving an input to the “pay now” user interface element 608, the provider computing system 102 may be configured to initiate a transfer of resources from an account associated with the customer device 120 to the shared account.

As described herein, the terms of withdrawal 304 may define one (or more) eligible members who can withdraw funds from the shared account. For example, the terms of withdrawal 304 may indicate one member of the shared account is responsible for paying the total deposited funds from each member to the common landlord or other payee. In some embodiments, the provider computing system 102 may be configured to transmit a notification to the customer devices 120 associated with the one or more eligible members to indicate they are eligible for withdrawal, as shown in the user interface 604 depicted in FIG. 6. For example, the provider computing system 102 may transmit the notification responsive to determining each member of the shared account has deposited their share of the payment. The notification may include a selectable option to make the withdrawal (e.g., the “withdraw” user interface element 610 of user interface 604). The notification may additionally or alternatively indicate a period of time in which the member is allowed to withdraw from the shared account and/or an amount the user is allowed to withdraw.

As described herein, the timeline 308 of the shared account rules 300 may define an amount of time for the shared account to be or remain active. In some embodiments, the timeline 308 may define a set term (e.g., 1 year, 6 months, etc.) in which the shared account is to remain active before expiring. Continuing with the above example, the set term may be equal to a term of a lease agreement among the members of the shared household. In some embodiments, the timeline 308 may define the shared account to be active indefinitely.

In some embodiments, the provider computing system 102 may be configured to determine when the shared account is set to expire, and may be configured to generate and provide a notification to each of the members of the shared account (e.g., via their respective customer devices 120) indicating when the shared account will expire. The timeline 308 may define an amount of time before the expiration date to transmit the notification (e.g., 1 month before, 2 weeks before, etc.). In some embodiments, as described herein, there may be a balance remaining in the shared account at the time of expiration and/or after all payments have been made among the shared household (e.g., if an actual utility bill was less than the deposit goal). In these embodiments, the terms of sharing 306 may define how the remaining balance of the shared account should be divided among the members of the shared account.

In some embodiments, the terms of sharing 306 may be defined according to contribution amounts from each user. For example, each member may contribute at various instances and amounts to the shared account. The provider computer system 102 may be configured to associate portions of the value of the shared account to each member. The provider computer system 102 may be configured to increase the portion associated with a particular member (e.g., member identifier) as the member contributes more to the shared account. The provider computer system 102 may be configured to divide the balance left within the shared account based on the portions associated with each member. In other words, the division of the remaining balance may be based on a ratio between deposits made by a first member to deposits made by a second member, and so on.

In some embodiments, the terms of sharing 306 may be defined according to particular needs of each member. For example, the provider computer system 102 may be configured to access account balances of each of the members. As part of initial access to the shared account and at various intervals, users of the customer device(s) 120 may provide or indicate a purpose or need for a withdrawal from the shared account (e.g., for a down payment to a home, to perform repairs of a home, etc.). In some embodiments, the provider computer system 102 may automatically rank purposes or needs of the users (e.g., using a machine learning model or artificial intelligence, such as RankNet/Ranks SVM, a support vector machine, etc.). In some embodiments, the users may assign a rank to the purposes or needs of the users. For example, following collecting each of the purposes, the provider computer system 102 may transmit a message or link to each of the customer devices 120. The customer devices 120 may display a user interface for receiving inputs which rank each of the purposes. The provider computer system 102 may be configured to aggregate the received inputs from the customer devices 120, and determine a master rank (e.g., based on, for example, an average ranking) of each of the purposes or needs.

In some embodiments, the terms of sharing 306 may be defined by a set ratio or allotment as part of the initial generation of the shared account. For example, a user requesting to generate the shared account may indicate, via one or more inputs to the customer device 120 associated with the user, that a first member is to receive 50% of the balance left in the shared account after a period of time, that a second member is to receive 25% of the balance left in the shared account after the period of time, etc. In some embodiments, the terms of sharing 306 may be defined to equally divide the balance remaining in the shared account among each of the members with access to the shared account.

The notification transmitted to each customer device 120 may indicate an amount awarded to each member, as depicted in the user interface 606 in FIG. 6, and/or may include a selectable option for a member to withdraw the awarded amount prior to expiration of the shared account (e.g., the “withdraw now” user interface element 612 of user interface 606). Responsive to receiving a selection of the “withdraw” user interface element, the provider computing system 102 may be configured to determine if all known upcoming payments associated with the shared account have been made (e.g., by parsing the terms of deposits 302). Responsive to determining all payments have been made, the provider computing system 102 may be configured to release the funds from the shared account to an account associated with the member. Responsive to determining one or more payments remain, the provider computing system 102 may be configured to transmit a second notification to the customer device 120 indicating the funds are not yet eligible for withdraw. The provider computing system 102 may be configured to automatically release funds to each eligible member responsive to the shared account expiring. This is non-conventional, as it allows members to contribute to a shared account for a period of time for practical purposes (e.g., to contribute to rental payments for a period of a lease agreement and to maintain separate funds left in the shared account following the expiration of the lease and the shared account).

In some embodiments, the notification to one or more of the customer devices 120 may include a selectable element to renew the shared account beyond the set expiration (e.g., if a household opts to renew a lease). The provider computing system 102 may be configured to extend the timeline 308 based on the original expiration (e.g., extend 1 year if the shared account was originally supposed to expire after 1 year) and/or transmit a prompt to the eligible member or administrator of the shared account to confirm or update the shared account rules 300 stored in the shared account database 112.

In some embodiments, the provider computing system 102 may be configured to separately maintain deposits and withdrawals for each member with access to the shared account. For example, the provider computing system 102 may be configured to tag each request for withdrawal or deposit with an identifier associated with the member (e.g., an account number, name, etc.). In some embodiments, the provider computing system 102 may be configured to generate a report including a list of transactions from an account of one of the members of the shared account to the shared account. For example, the provider computing system 102 may be configured to generate a report in a standard file format stored in the account database 110 or the shared account database 112 responsive to receiving an input to a customer device 120 indicating a user wishes to see past transactions (e.g., responsive to an input to a “view transactions” element on a user interface of the customer device 120). This is non-conventional, as it allows users to contribute to a shared account, while maintaining transaction records separate for practical purposes (e.g., for tax purposes, later unevenly apportioned withdrawals among members).

In some embodiments, the provider computing system 102 may be configured to provider automatic recommendations (e.g., pop-up notifications) to one or more customer devices based on an amount of time the shared account has been active. The machine learning engine 108 may be configured to determine, using one or more machine learning models, common activity associated with shared accounts based on information stored in the shared accounts database from one or more stored shared accounts. For example, the machine learning engine 108 may be configured to determine, based on one or more machine learning models described herein, that members usually withdraw resources from the shared account at least once within 10 years of the shared account being generated. Therefore, the provider computing system 102 may be configured to determine no withdrawals have been made in 10 years and transmit, to a customer device 120, a notification including a recommendation to withdraw from the shared account. In some embodiments, the provider computing system 102 may be configured to provide automatic recommendations responsive to receiving an indication from a customer device 120 to enroll in automatic recommendations (e.g., with the request to generate the shared account and/or after the shared account has been generated).

In some embodiments, the provider computing system 102 may be configured to automatically initiate a transfer of resources from the shared account to an investment account stored in the account database 110 after a predetermined period of time of the shared account being active. For example, automatically initiate a transfer of resources from the shared account to an investment account responsive to receiving an indication from a customer device 120 to enroll in an investment account after a period of time (e.g., with the request to generate the shared account and/or after the shared account has been generated). By way of example, the provider computing system 102 may be configured to transfer a subset of the resources within the shared account to an investment account of the provider institution 20 years after the shared account has been generated.

The embodiments described herein have been described with reference to drawings. The drawings illustrate certain details of specific embodiments that implement the systems, methods and programs described herein. However, describing the embodiments with drawings should not be construed as imposing on the disclosure any limitations that may be present in the drawings.

It should be understood that no claim element herein is to be construed under the provisions of 35 U.S.C. § 112(f), unless the element is expressly recited using the phrase “means for.”

As used herein, the term “circuit” may include hardware structured to execute the functions described herein. In some embodiments, each respective “circuit” may include software for configuring the hardware to execute the functions described herein. The circuit may be embodied as one or more circuitry components including, but not limited to, processing circuitry, network interfaces, peripheral devices, input devices, output devices, sensors, etc. In some embodiments, a circuit may take the form of one or more analog circuits, electronic circuits (e.g., integrated circuits (IC), discrete circuits, system on a chip (SOC) circuits), telecommunication circuits, hybrid circuits, and any other type of “circuit.” In this regard, the “circuit” may include any type of component for accomplishing or facilitating achievement of the operations described herein. For example, a circuit as described herein may include one or more transistors, logic gates (e.g., NAND, AND, NOR, OR, XOR, NOT, XNOR), resistors, multiplexers, registers, capacitors, inductors, diodes, wiring, and so on.

Accordingly, the “circuit” may also include one or more processors communicatively coupled to one or more memory or memory devices. In this regard, the one or more processors may execute instructions stored in the memory or may execute instructions otherwise accessible to the one or more processors. In some embodiments, the one or more processors may be embodied in various ways. The one or more processors may be constructed in a manner sufficient to perform at least the operations described herein. In some embodiments, the one or more processors may be shared by multiple circuits (e.g., circuit A and circuit B may include or otherwise share the same processor which, in some example embodiments, may execute instructions stored, or otherwise accessed, via different areas of memory). Alternatively or additionally, the one or more processors may be structured to perform or otherwise execute certain operations independent of one or more co-processors. In other example embodiments, two or more processors may be coupled via a bus to enable independent, parallel, pipelined, or multi-threaded instruction execution. Each processor may be implemented as one or more general-purpose processors, application specific integrated circuits (ASICs), field programmable gate arrays (FPGAs), digital signal processors (DSPs), or other suitable electronic data processing components structured to execute instructions provided by memory. The one or more processors may take the form of a single core processor, multi-core processor (e.g., a dual core processor, triple core processor, quad core processor), microprocessor, etc. In some embodiments, the one or more processors may be external to the apparatus, for example the one or more processors may be a remote processor (e.g., a cloud based processor). Alternatively or additionally, the one or more processors may be internal and/or local to the apparatus. In this regard, a given circuit or components thereof may be disposed locally (e.g., as part of a local server, a local computing system) or remotely (e.g., as part of a remote server such as a cloud based server). To that end, a “circuit” as described herein may include components that are distributed across one or more locations.

An exemplary system for implementing the overall system or portions of the embodiments might include a general purpose computing devices in the form of computers, including a processing unit, a system memory, and a system bus that couples various system components including the system memory to the processing unit. Each memory device may include non-transient volatile storage media, non-volatile storage media, non-transitory storage media (e.g., one or more volatile and/or non-volatile memories), etc. In some embodiments, the non-volatile media may take the form of ROM, flash memory (e.g., flash memory such as NAND, 3D NAND, NOR, 3D NOR), EEPROM, MRAM, magnetic storage, hard discs, optical discs, etc. In other embodiments, the volatile storage media may take the form of RAM, TRAM, ZRAM, etc. Combinations of the above are also included within the scope of machine-readable media. In this regard, machine-executable instructions include, for example, instructions and data which cause a general purpose computer, special purpose computer, or special purpose processing machines to perform a certain function or group of functions. Each respective memory device may be operable to maintain or otherwise store information relating to the operations performed by one or more associated circuits, including processor instructions and related data (e.g., database components, object code components, script components), in accordance with the example embodiments described herein.

It should also be noted that the term “input devices,” as described herein, may include any type of input device including, but not limited to, a keyboard, a keypad, a mouse, joystick or other input devices performing a similar function. Comparatively, the term “output device,” as described herein, may include any type of output device including, but not limited to, a computer monitor, printer, facsimile machine, or other output devices performing a similar function.

Any foregoing references to currency or funds are intended to include fiat currencies, non-fiat currencies (e.g., precious metals), and math-based currencies (often referred to as cryptocurrencies). Examples of math-based currencies include Bitcoin, Litecoin, Dogecoin, and the like.

It should be noted that although the diagrams herein may show a specific order and composition of method steps, it is understood that the order of these steps may differ from what is depicted. For example, two or more steps may be performed concurrently or with partial concurrence. Also, some method steps that are performed as discrete steps may be combined, steps being performed as a combined step may be separated into discrete steps, the sequence of certain processes may be reversed or otherwise varied, and the nature or number of discrete processes may be altered or varied. The order or sequence of any element or apparatus may be varied or substituted according to alternative embodiments. Accordingly, all such modifications are intended to be included within the scope of the present disclosure as defined in the appended claims. Such variations will depend on the machine-readable media and hardware systems chosen and on designer choice. It is understood that all such variations are within the scope of the disclosure. Likewise, software and web implementations of the present disclosure could be accomplished with standard programming techniques with rule-based logic and other logic to accomplish the various database searching steps, correlation steps, comparison steps and decision steps.

The foregoing description of embodiments has been presented for purposes of illustration and description. It is not intended to be exhaustive or to limit the disclosure to the precise form disclosed, and modifications and variations are possible in light of the above teachings or may be acquired from this disclosure. The embodiments were chosen and described in order to explain the principals of the disclosure and its practical application to enable one skilled in the art to utilize the various embodiments and with various modifications as are suited to the particular use contemplated. Other substitutions, modifications, changes and omissions may be made in the design, operating conditions and embodiment of the embodiments without departing from the scope of the present disclosure as expressed in the appended claims.

What is claimed is:

1. A method comprising:
receiving, by a computing system, a request from a first user device of a first user, the request to form a shared account accessible by a second user, wherein the request includes a plurality of rules associated with the shared account;
generating, by the computing system, the shared account;
linking, by the computing system, a first account of the first user with the shared account;
identifying, by the computing system, the second user based on the request to form the shared account;
transmitting, by the computing system, a notification to a second user device associated with the second user, the notification indicating the second user has access to the shared account;
receiving, by the computing system, an input via the second user device indicating acceptance of access to the shared account;
linking, by the computing system, a second account of the second user with the shared account;
receiving, by the computing system, a second input via the second user device indicating a selection to initiate an outbound transfer of resources from the shared account to the second account, wherein the input includes a selection of a category;
determining, by the computing system, that the category meets at least one of the plurality of rules; and
initiating, by the computing system and responsive to determining that the category meets the at least one of the plurality of rules, the outbound transfer of resources from the shared account to the second account.

2. The method of claim 1, further comprising:
receiving, by the computing system, an input via the first user device indicating a selection to initiate an inbound transfer of resources from the first account to the shared account;
wherein the input via the first user device indicates a selected category of a plurality of predetermined categories earmarking the transfer of resources; and
wherein determining that the category of the outbound transfer meets at least one of the plurality of rules further comprises determining, by the computing system, that the category matches the selected category.

3. The method of claim 1, further comprising determining, by the computing system, based on the plurality of rules associated with the shared account, that the second user is eligible to request the outbound transfer of funds.

4. The method of claim 1, wherein the first account and the shared account are held at a first provider, the second account is held at a second provider, and the outbound transfer of resources is initiated via a third party service provider.

5. The method of claim 1, wherein the plurality of rules associated with the shared account comprises an expiration date of the shared account, the method further comprising:
determining, by the computing system, that an amount of resources remain in the shared account at the expiration date;
initiating, by the computing system, a first outbound transfer of a first subset of the amount of resources remaining in the shared account to the first account; and
initiating, by the computing system, a second outbound transfer of a second subset of the amount of resources remaining in the shared account to the second account.

6. The method of claim 5, wherein the first subset and the second subset are based on an allotment of resources between the first account and the second account defined by the plurality of rules associated with the shared account.

7. The method of claim 5, wherein a ratio between the first subset and the second subset is equal to a ratio of an inbound transfer of resources from the first account to an inbound transfer of resources from the second account.

8. The method of claim 1, wherein the plurality of rules associated with the shared account define a balance goal of the shared account, the method further comprising:
determining, by the computing system, based on the balance goal, a first amount of resources owed by the first account and a second amount of resources owed by the second account;
transmitting, by the computing system, a first notification to the first user device indicating to initiate a first inbound transfer of resources from the first account to the shared account; and
transmitting, by the computing system, a second notification to the second user device indicating to initiate a second inbound transfer of resources from the second account to the shared account.

9. A computing system, comprising:
a network interface configured to communicate with a plurality of user devices;
a first database structured to store a plurality of accounts of a provider;
a second database structured to store a plurality of shared accounts; and
a processing circuit comprising one or more processors and memory, the processing circuit configured to:
receive, via the network interface, a request from a first user device of a first user, the request to form a shared account accessible by a second user, wherein the request includes a plurality of rules associated with the shared account;
generate the shared account;
link a first account of the first user with the shared account;
identify the second user based on the request to form the shared account;
transmit, via the network interface, a notification to a second user device associated with the second user, the notification indicating the second user has access to the shared account;
receive, via the network interface, an input to the second user device indicating acceptance of access to the shared account;
link a second account of the second user with the shared account;
receive, via the network interface, a second input to the second user device indicating a selection to initiate an outbound transfer of resources from the shared account to the second account, wherein the input includes a selection of a category;
determine that the category meets at least one of the plurality of rules; and
initiate, responsive to determining that the category meets the at least one of the plurality of rules, the outbound transfer of resources from the shared account to the second account.

10. The computing system of claim 9, wherein the processing circuit is further configured to:
receive, via the network interface, an input to the first user device indicating a selection to initiate an inbound transfer of resources from the first account to the shared account;
wherein the input to the first user device indicates a selected category of a plurality of predetermined categories earmarking the transfer of resources; and
wherein determining that the category of the outbound transfer meets at least one of the plurality of rules comprises determining that the category matches the selected category.

11. The computing system of claim 9, wherein the processing circuit is further configured to determine, based on the plurality of rules associated with the shared account, that the second user is eligible to request the outbound transfer of funds.

12. The computing system of claim 9, wherein the first account and the shared account are held at a first provider, the second account is held at a second provider, and the outbound transfer of resources is initiated via a third party service provider communicably coupled to the computing system.

13. The computing system of claim 9, wherein the plurality of rules associated with the shared account comprises an expiration date of the shared account, and the processing circuit is further configured to:
determine that an amount of resources remain in the shared account at the expiration date;
initiate a first outbound transfer of a first subset of the amount of resources remaining in the shared account to the first account; and
initiate a second outbound transfer of a second subset of the amount of resources remaining in the shared account to the second account.

14. The computing system of claim 13, wherein the first subset and the second subset are based on an allotment of resources between the first account and the second account defined by the plurality of rules associated with the shared account.

15. The computing system of claim 13, wherein a ratio between the first subset and the second subset is equal to a ratio of an inbound transfer of resources from the first account to an inbound transfer of resources from the second account.

16. The computing system of claim 9, wherein the plurality of rules associated with the shared account define a balance goal of the shared account, and the processing circuit is further configured to:
determine, based on the balance goal, a first amount of resources owed by the first account and a second amount of resources owed by the second account;
transmit, via the network interface, a first notification to the first user device indicating to initiate a first inbound transfer of resources from the first account to the shared account; and
transmit, via the network interface, a second notification to the second user device indicating to initiate a second inbound transfer of resources from the second account to the shared account.

17. A non-transitory computer readable medium storing instructions that, when executed by one or more processors of a processing system, cause the processing system to:
receive, via a network interface, a request from a first user device of a first user, the request to form a temporary shared account accessible by the first user and by a second user for a period of time, wherein the request includes a plurality of rules associated with the shared account;
generate the shared account;
link a first account of the first user with the shared account;
identify the second user based on the request to form the shared account;
transmit, via the network interface, a notification to a second user device associated with the second user, the notification indicating the second user has access to the shared account;
receive, via the network interface, an input to the second user device indicating acceptance of access to the shared account;
link a second account of the second user with the shared account;
receive, via the network interface, a second input to the second user device indicating a selection to initiate an outbound transfer of resources from the shared account to the second account, wherein the input includes a selection of a category;
determine that the category meets at least one of the plurality of rules; and
initiate, responsive to determining that the category meets the at least one of the plurality of rules, the outbound transfer of resources from the shared account to the second account.

18. The non-transitory computer readable medium of claim 17, wherein the instructions further cause the processing system to:
receive, via the network interface, an input to the first user device indicating a selection to initiate an inbound transfer of resources from the first account to the shared account;
wherein the input to the first user device indicates a selected category of a plurality of predetermined categories earmarking the transfer of resources; and
wherein determining that the category of the outbound transfer meets at least one of the plurality of rules comprises determining that the category matches the selected category.

19. The non-transitory computer readable medium of claim 17, wherein the first account and the shared account are held at a first provider, the second account is held at a second provider, and the outbound transfer of resources is initiated via a third party service provider.

20. The non-transitory computer readable medium of claim 17, wherein the instructions further cause the processing system to:
determine that an amount of resources remain in the shared account after the period of time;
initiate a first outbound transfer of a first subset of the amount of resources remaining in the shared account to the first account; and
initiate a second outbound transfer of a second subset of the amount of resources remaining in the shared account to the second account.
